(19) United States
(12) Patent Application Publication
(10) Pub. No.: US 2018/0060389 A1
(43) Pub. Date: Mar. 1, 2018

(54) QUERY OPTIMIZATION OVER DISTRIBUTED HETEROGENEOUS EXECUTION ENGINES

(71) Applicant: SAP SE, Walldorf (DE)

(72) Inventor: Sangyong Hwang, Heidelberg (DE)

(21) Appl. No.: 15/249,704

(22) Filed: Aug. 29, 2016

(51) Int. Cl. G06F 17/30

(52) U.S. Cl. CPC G06F 17/30463; G06F 17/30528

(57) ABSTRACT

A system includes reception of a database query, determination of a first logical query execution plan to execute the database query over a plurality of heterogeneous execution engines, selection of a first logical operator of a first operation level of the first logical query execution plan, identification of a first one or more physical operators corresponding to the first logical operator and an output format of each of the first one or more physical operators, each of the first one or more physical operators provided by a respective one of the plurality of heterogeneous distributed execution engines, selection of a second logical operator of a second operation level of the first logical query execution plan, the second logical operator to receive output from the first logical operator, identification of a second one or more physical operators corresponding to the second logical operator, each of the second one or more physical operators provided by a respective one of the plurality of heterogeneous execution engines, determination of a first resource usage estimate for each of the first one or more physical operators, determination of one or more second resource usage estimates for each of the second one or more physical operators, based on the respective output format of each of the first one or more physical operators, and determination of one of the first one or more physical operators and one of the second one or more physical operators based on the determined first resource usage estimates and the determined second resource usage estimates.

### BACKGROUND

Database systems may provide distributed data storage and/or query execution. For example, a database system may include one or more types of distributed database management systems (DBMSs) managing one or more different types of distributed data. This heterogeneous architecture may require the processing of queries which span multiple types of DBMSs.

According to federated query processing, a global query spanning multiple DBMSs is split into local queries to be processed by corresponding DBMSs. The local queries may be generated based on the location of data and/or the query execution abilities of each DBMS. However, current systems are unable to optimize the generation of the local queries based on the resource-usage of each query and its respective inputs.

### BRIEF DESCRIPTION OF THE DRAWINGS

FIG. 1 is a block diagram of a system according to some embodiments.

FIGS. 2A through 2C comprise a flow diagram of a process according to some embodiments.

FIG. 3 illustrates execution trees of logical operators of two logical query plans according to some embodiments.

FIGS. 4 through 10 comprise tabular representations of data to illustrate optimization of query execution according to some embodiments.

FIG. 11 is a block diagram of an apparatus according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

Generally, some embodiments relate to query optimization over multiple heterogeneous execution engines based on resource-usage estimates of various combinations of physical operators which may be used to implement logical operators of possible logical query execution plans. Resource-usage may be estimated based on, in part, formats of data input to the physical operators of a given combination of physical operators and conversions which may be required by the physical operators. Some embodiments provide plug-in support for additional execution engines.

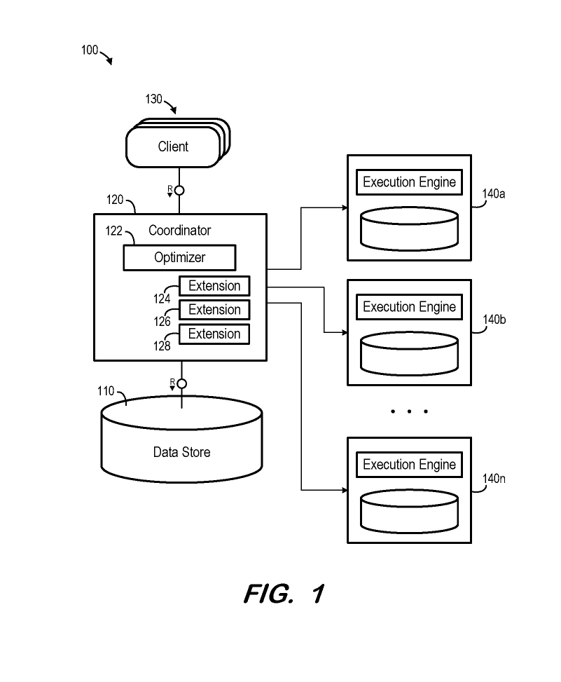

FIG. 1 is a block diagram of architecture 100 according to some embodiments. Embodiments are not limited to architecture 100.

Architecture 100 includes data store 110, coordinator 120, clients 130, and distributed storage systems 150a through 150n. Generally, coordinator 120 receives queries from clients 130 and provides results based on data stored within data store 110 and/or distributed storage systems 140a through 140n. As will be described in detail below, optimizer 122 uses extensions 124 through 128 to identify physical operators provided by the execution engines of distributed storage systems 140a through 140n, and to estimate resource usage of the identified physical operators. This information may be used to optimize execution of a query received from clients 130.

Clients 130 may comprise database applications executing on an application server, which in turn serve requests received from end-users. Coordinator 120 may comprise a component of a DBMS which serves requests to query, retrieve, create, modify (update), and/or delete data of data store 110, and also performs administrative and management functions. Such functions may include snapshot and backup management, indexing, optimization, garbage collection, and/or any other database functions that are or become known. Such a DBMS may also provide application logic, such as database procedures and/or calculations, according to some embodiments. This application logic may comprise scripts, functional libraries and/or compiled program code. Each of distributed storage systems 140a through 140n may comprise components to provide similar functions.

Coordinator 120 may provide any suitable protocol interfaces through which clients 130 may communicate. For example, coordinator 120 may include a HyperText Transfer Protocol (HTTP) interface supporting a transient request/response protocol over Transmission Control Protocol (TCP), and/or a WebSocket interface supporting non-transient full-duplex communications between coordinator 120 and any clients 130 which implement the WebSocket protocol over a single TCP connection.

Coordinator 120 may communicate with data store 110 using a custom interface for exchanging execution plans and intermediate results, as well as database management interfaces such as, but not limited to, Open Database Connectivity (ODBC) and Java Database Connectivity (JDBC) interfaces. These interfaces may use custom interfaces as well as Structured Query Language (SQL) to manage and query data stored in data store 110 and/or distributed storage systems 140a through 140n.

Data store 110 and/or distributed storage systems 140a through 140n may comprise any query-responsive data source or sources that are or become known, including but not limited to a structured-query language (SQL) relational database management system. Each of systems 140a through 140n includes an execution engine and a data store. An execution engine which is optimized for slowly-changing time-series data may store values in its data store as differences to prior values, rather than as absolute values, and an execution engine optimized for handling semi-structured data may store metadata along with the data in its corresponding data store.

Each execution engine may provide one or more physical operators corresponding to one or more logical operators. The physical operators may comprise processor-executable program code which is executable to perform corresponding logical operations (e.g., JOIN, SELECT, etc.) on the data of the corresponding data store. The set of logical operators for which an execution engine includes one or more physical operators might not be identical across execution engines. Moreover, a physical operator provided by one execution engine and corresponding to a logical operator may differ from a physical operator provided by another execution engine and corresponding to the same logical operator. The data format output by various physical operators of various execution engines (even those corresponding to a same logical operator) may differ as well.

Data store 110 and/or distributed storage systems 140a through 140n may comprise a relational database, a multi-dimensional database, an eXtendable Markup Language (XML) document, or any other data storage system storing structured and/or unstructured data. The data of data store 110 and/or distributed storage systems 140a through 140n may be distributed among several relational databases, dimensional databases, and/or other data sources. Embodiments are not limited to any number or types of data sources.

In some embodiments, the data of data store 110 and/or distributed storage systems 140a through 140n may comprise one or more of conventional tabular data, row-based data, column-based data, and object-based data. Moreover, the data may be indexed and/or selectively replicated in an index to allow fast searching and retrieval thereof. Data store 110 and/or distributed storage systems 140a through 140n may support multi-tenancy to separately support multiple unrelated clients by providing multiple logical database systems which are programmatically isolated from one another.

Data store 110 may implement an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in Random Access Memory (e.g., cache memory for storing recently-used data) and one or more fixed disks (e.g., persistent memory for storing their respective portions of the full database). Each of distributed storage systems 140a through 140n may comprise a single or distributed database, using cache memory and fixed disks for traditional data storage, but one or more of distributed storage systems 140a through 140n may alternatively comprise an in-memory database according to some embodiments.

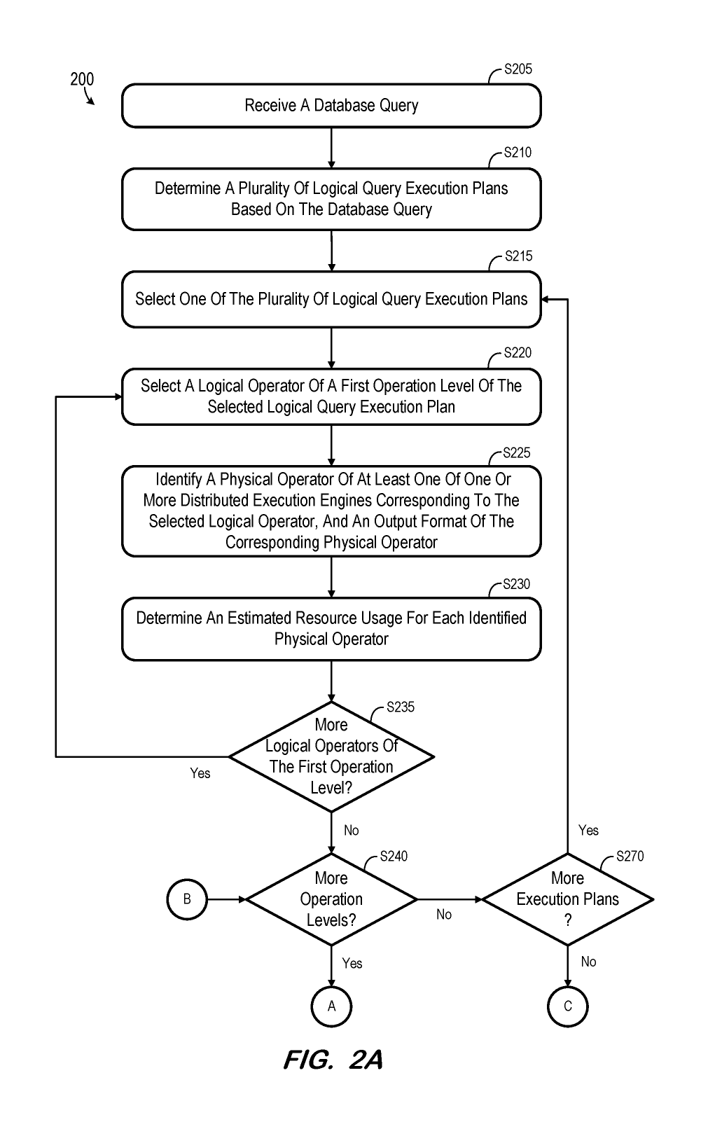

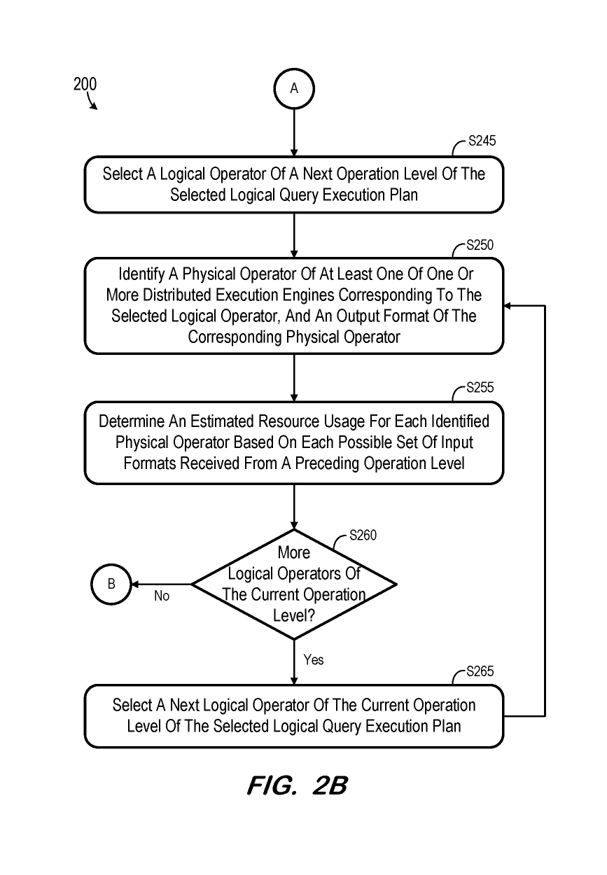

FIG. 2 comprises a flow diagram of process 200 according to some embodiments. In some embodiments, various hardware elements of system 100 execute program code to perform process 200. Process 200 and all other processes mentioned herein may be embodied in computer-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a database query is received at S205. The database query may conform to any query language supported by coordinator 120 (or by a DBMS including coordinator 120). According to some embodiments, database query is an SQL query. The database query may or may not involve data of at least one of distributed storage systems 140a through 140n.

By way of example, it will be assumed that the following database query is received at S205:

select * from T inner join S on T.a=S.a inner join Ron S.b=R.b

where T.c>100 and S.c<100,

where tables T, S and R reside, respectively, on systems 140a, 140b and 140n.

Next, at S210, a plurality of logical query execution plans are determined based on the database query. For example, using known techniques, optimizer 122 may generate two or more query execution plans which may be used to acquire the results specified by the received database query.

Continuing the present example, it will be assumed that the following two logical query execution plans at S210:

(1) Project(*, InnerJoin(S.b=R.b, InnerJoin(T.a=S.a, Select(T.c>100, T), Select(S.c<100, S)), R))
(2) Project(*, InnerJoin(T.a=S.a, Select(T.c>100, T), InnerJoin(S.b=R.b, Select(S.c<100, S), R)))

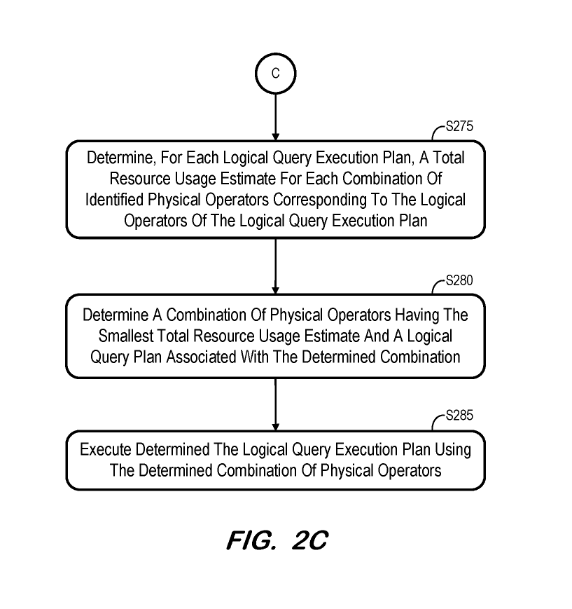

According to Plan (1), tables T and S are joined after executing the filters on T and S, respectively and then table R is joined. In Plan (2), tables S and R are joined after executing the filter on S, and then table T is joined after executing the filter on T. FIG. 3 illustrates operation tree 310 corresponding to Plan (1) and operation tree 320 corresponding to Plan (2) according to some embodiments.

Each of trees 310 and 320 includes nodes associated with the logical operators of its corresponding query execution plan. The nodes are arranged according to the order of operations of each execution plan, with the output of lower nodes and serving as inputs to the higher-level nodes to which they are connected.

Specifically, node LO₁ of operation tree 310 corresponds to filtering table T and node LO₂ of operation tree 310 corresponds to filtering table S. Node LO₃ corresponds to the join of tables T and S, and Node LO₄ corresponds to the subsequent join of table R. Node LO₅ of operation tree 320 corresponds to filtering table T and node LO₆ of operation tree 320 corresponds to filtering table S. Node LO₇ corresponds to the join of tables S and R, and Node LO₈ corresponds to the subsequent join of filtered table T.

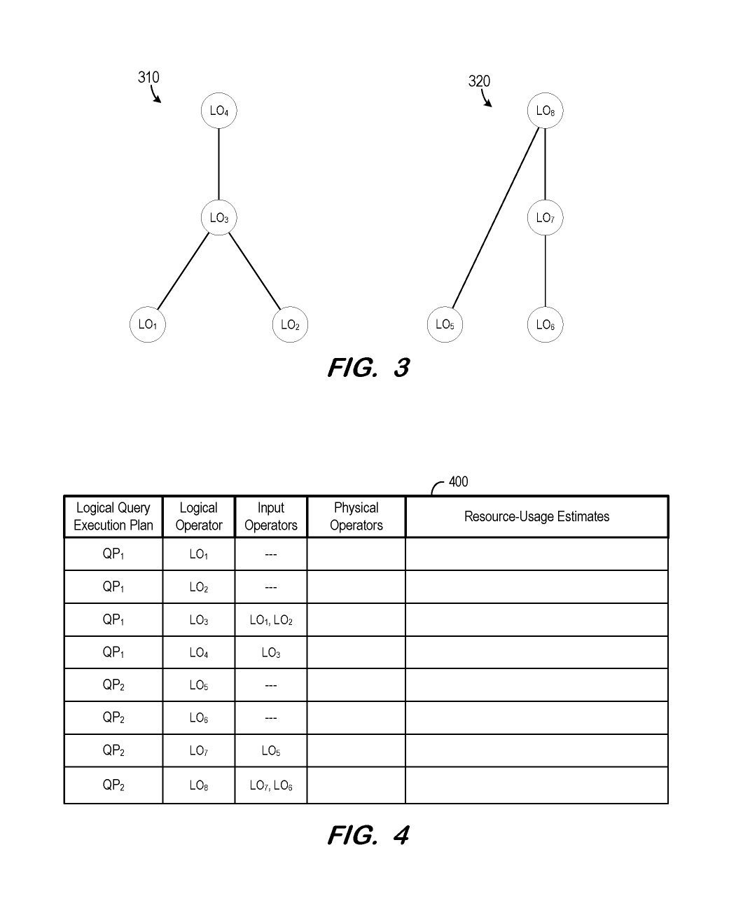

Table 400 of FIG. 4 includes information generated during process 200 according to some embodiments. As shown, the information specifies logical operators of each logical query execution plan and any associated input logical operators. Table 400 of FIG. 4 is populated to reflect operation trees 310 and 320 of FIG. 3, denoted as QP₁ and QP₂, respectively. The information of table 400 may be stored, in relational tables or other formats, in a volatile memory accessible to optimizer 122 and/or in data store 110.

One of the plurality of logical query execution plans is selected at S215, and a logical operator of the selected logical query execution plan is selected at S220. The selected logical operator is any logical operator of the first (i.e., lowest) level in the order of operations of the logical query execution plan. For purposes of the following description, it will be assumed that Plan (1) is initially selected at S215 and that logical operator LO₁ is selected at S220.

At S225, one or more physical operators provided by the execution engines of systems 140a through 140n and corresponding to the selected logical operator are identified. Also identified is the output format of each of the one or more identified physical operators. According to some embodiments of S225, optimizer 122 transmits a request to extensions 124 through 128 to return any physical operators corresponding to logical operation LO₁ (i.e., Select(T.c >100, T)).

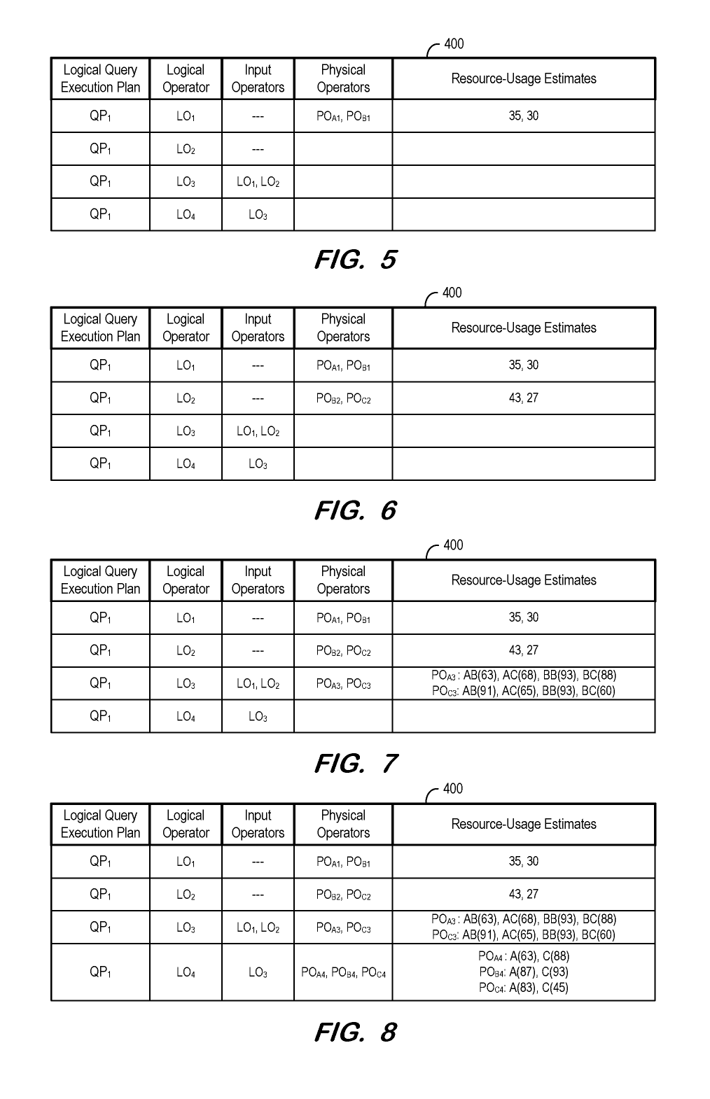

According to the present example, it is determined that execution engines of systems 140a and 140b include physical operators corresponding to logical operator LO₁. FIG. 5 illustrates table 400 including identifiers of these physical operators, PO_{A1} and PO_{B1}. In this regard, the execution engines of systems 140a, 140b and 140n will be denoted as A, B and C, respectively. The output format of the physical operators of execution engines A, B and C will also be denoted as A, B and C, respectively. In some embodiments, the physical operators of two or more different execution engines may be associated with a same output format, and/or a single execution engine may include physical operators which output data in different output formats.

An estimated resource usage (e.g., resource cost) is determined for each identified physical operator at S230. The resource usage estimate may be requested from an extension 124, 126 or 128 associated with the execution engine corresponding to the physical operator. Embodiments of S230 may employ any system that is or becomes known for estimating the resource usage, or cost, of execution of a physical query operator. The estimate may be based on statistics of the table(s) on which the physical operators will operate, and/or on any other information. FIG. 5 also shows the resource-usage estimates corresponding to each of identified physical operators, PO_{A1} (i.e., 35) and PO_{B1} (i.e., 30).

It is then determined at S235 whether the first operation level of the selected logical query execution plan includes any additional logical operators. The present example includes one additional first-level logical operator, so flow returns to S220 to select that logical operator (i.e., LO₂: Select(S.c<100, S)).

Flow then proceeds to S225 as described above to identify at least one physical operator of at least one execution engine which corresponds to the selected logical operator, and an output format of each identified physical operator. FIG. 6 illustrates the identification at S225 of physical operators PO_{B2} and PO_{C2}, of execution engines B and C, and having output formats B and C. FIG. 6 also illustrates the estimated resource usage for the identified physical operators PO_{B2} (i.e., 43) and PO_{C2} (i.e., 27), as determined at S230.

Next, at S235, it is determined that the first operation level does not include any additional logical operators. It is then determined, at S240, whether the currently-selected logical query execution plan includes additional operation levels. Flow proceeds from S240 to S245 in the present example because operation tree 310 of execution plan QP₁ includes two additional levels.

A logical operator of a next operation level of the currently-selected logical query execution plan is selected at S245. Logical operator LO₃ is selected and, at S250, one or more physical operators and their output formats are identified as described with respect to S225. Table 400 of FIG. 7 is updated to illustrate the identification of physical operators PO_{A3} and PO_{C3} of execution engines A and C, respectively.

An estimated resource usage is determined for each identified physical operator at S255. Unlike S230, determination of the estimated resource usage takes into account the format of data input to the physical operator from one or more physical operators of a lower operation level. For example, logical operator LO₃ receives data from logical operators LO₁ and LO₂, therefore the resource usage of a physical operator identified for logical operator LO₃ is based on the output format of whatever physical operators are used to implement logical operators LO₁ and LO₂.

Consequently, at S255, and for each identified physical operator corresponding to logical operator LO₃, an estimated resource usage is determined based on each possible combination of the physical operators identified for logical operators LO₁ and LO₂. As shown in FIG. 7, and for each of identified physical operators PO_{A3} and PO_{C3}, a resource usage estimate is determined for each of four possible combinations of input physical operators PO_{A1}, PO_{B1}, PO_{B2}, and PO_{C2}. These combinations consist of PO_{A1} and PO_{B2} (denoted AB in FIG. 7), PO_{A1} and PO_{C2} (AC), PO_{B1} and PO_{B2} (BB), and PO_{B1} and PO_{C2} (BC).

The estimated resource usages may depend upon the format of the input data generated by the input physical operators. For example, if input physical operators PO_{B1} and PO_{B2} (BB) are used to implement logical operators LO₁ and LO₂, respectively, then physical operator PO_{A3} requires two conversions from the “B” input format, resulting in a higher estimated resource usage (i.e., 93 vs. 63) than in a case where input physical operators PO_{A1} and PO_{B2} (AB) are used for logical operators LO₁ and LO₂, which requires only one format conversion.

It is determined at S260 whether the current operation level includes more logical operators. If so, a next logical operator of the current operation level is selected at S265 and flow returns to S250 and continues as described above. If the current operation level does not include more logical operators, flow returns to S240 to determine whether the current logical query execution plan includes additional operation levels. With respect to the present example, the current operation level includes no more logical operators and the execution plan includes one more operation level, therefore flow proceeds from S260 to S240 and on to S245.

A logical operator of a next operation level of the currently-selected logical query execution plan is selected at S245. Logical operator LO₄ is selected and one or more physical operators and their output formats are identified at S250 as described above. Table 400 of FIG. 8 illustrates the identification at S250 of physical operators PO_{A4}, PO_{B4} and PO_{C4} of execution engines A, B and C, respectively.

As mentioned above, an estimated resource usage is determined for each identified physical operator at S255. Again, the determination of the estimated resource usage takes into account the format of data input to the physical operator from one or more physical operators of a lower operation level. Logical operator LO₄ receives data only from logical operator LO₃, however logical operator LO₃ may be implemented by either of two physical operators, PO_{A3} and PO_{C3}.

Accordingly, an estimated resource usage is determined for each of the three identified physical operators PO_{A4}, PO_{B4} and PO_{C4}, for each of two possible input formats (i.e., the formats output by physical operators, PO_{A3} and PO_{C3}). In this regard, FIG. 8 shows two resource usage estimates for each of the three identified physical operators PO_{A4}, PO_{B4} and PO_{C4}.

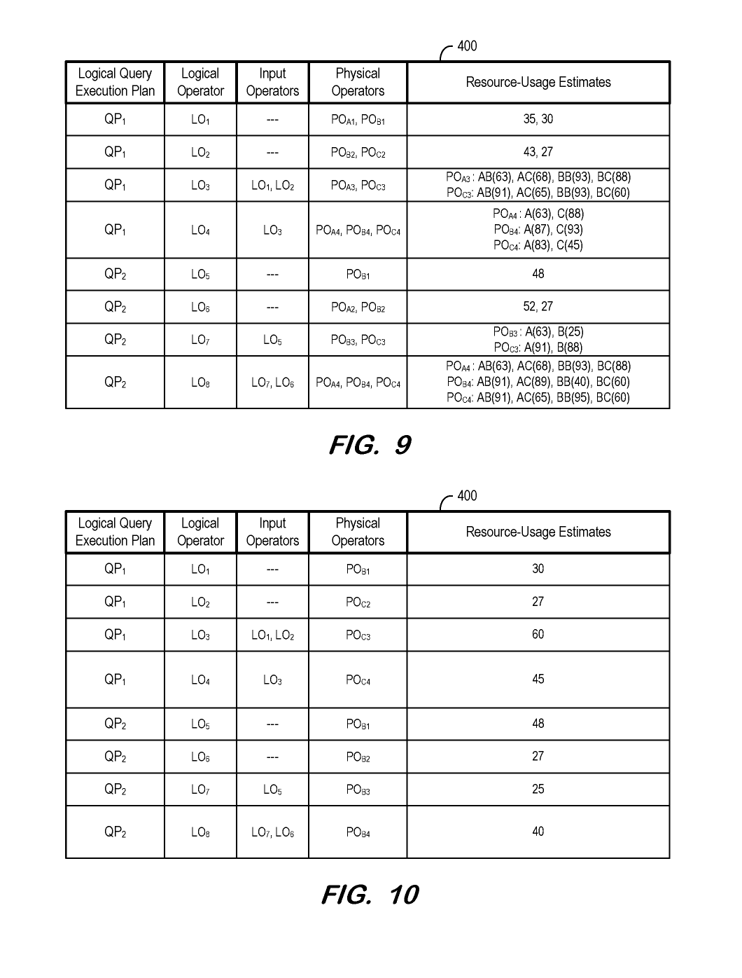

Flow returns to S240 because the current operation level does not include more logical operators. The current logical query execution plan does not include additional operation levels so flow proceeds to S270 to determine whether each of the plurality of logical execution plans has been processed. If not, flow returns to S215 to select a next logical query execution plan and flow continues as described above. FIG. 9 illustrates table 400 after execution of S215-S270 with respect to logical query execution plan QP₂.

Flow proceeds from S270 to S275 in response to determining that all logical query execution plans have been processed. At S275, a total resource usage estimate is determined for each logical query execution plan, for each combination of identified physical operators corresponding to the logical operators of the logical query execution plan. For example, in the case of query plan QP₁, there are four possible combinations of inputs (i.e., AB, AC, BB and BC) to logical operator LO₃, and two physical operators which could implement logical operator LO₃ (i.e., PO_{A3} and PO_{C3}). Accordingly, there are eight possible combinations of physical operators which may produce an input to logical operator LO₄. Since three physical operators have been identified which could implement logical operator LO₄ (i.e., PO_{A4}, PO_{B4} and PO_{C4}), there are twenty-four combinations of four physical operators (i.e., one for each of logical operators LO₁, LO₂, LO₃ and LO₄) which may implement query plan QP₁. Using similar logic, there are twelve combinations of four physical operators (i.e., one for each of logical operators LO₅, LO₆, LO₇ and LO₈) which may implement query plan QP₂. Total resource usage estimates are determined for each of these thirty-six combinations at S275.

For example, one of the twenty-four combinations for query plan QP₁ consists of physical operators PO_{B1}, PO_{C2}, PO_{A3} and PO_{A4}. Referring to table 400 of FIG. 9, the total resource usage estimate determined for this combination is 30+27+88+63=208. For the combination of physical operators PO_{B1}, PO_{B2}, PO_{B3} and PO_{B4} of query plan QP₂, the total determined resource usage estimate is 48+27+25+40=140.

Next, at S280, a combination of physical operators having the smallest total resource usage estimate is determined, as well as a logical query plan associated with the determined combination. For example, if resource usage estimates were determined only for the above two combinations of physical operators, then the combination PO_{B1}, PO_{B2}, PO_{B3} and PO_{B4}, and its associated logical execution query plan QP₂, would be determined at S280 because 140<280.

Embodiments are not limited to determination of combination of physical operators having the smallest total resource usage estimate. Considerations in addition to resource usage may be taken into account at S280 such that the determined combination and logical query execution plan are not those which correspond to the smallest total resource usage estimate. These considerations may include, but are not limited to, response time to the delivery of the first result row, relative system loads between the distributed execution engines and relative usage preferences between the distributed execution engines.

The logical query execution plan determined at S280 is then executed at S285, using the combination of physical plan operators determined at S280. Execution of the logical query execution plan may comprise coordinator 120 issuing instructions to appropriate ones of distributed systems 140a-140n depending on the sequence of operations of the logical query plan and on the execution engine providing the required physical operator.

For example, assuming that logical execution query plan QP₂, is to be executed using combination PO_{B1}, PO_{B2}, PO_{B3} and PO_{B4}, coordinator 120 issues an instruction to the execution engine of system 140b to execute node LO₅ using physical operator PO_{B1}. Coordinator 120 also issues an instruction to the execution engine of system 140b to execute node LO₆ using physical operator PO_{B2} and to use the output as input to execute node LO₇ using physical operator PO_{B3}. Lastly, coordinator 120 issues an instruction to the execution engine of system 140b to execute node LO₈ using physical operator PO_{B4}, and using the output of physical operator PO_{B1} (which executed node LO₅) and the output of physical operator PO_{B3} (which executed node LO₇).

If, for example, it was determined at S280 that logical execution query plan QP₁ is to be executed using combination PO_{B1}, PO_{C2}, PO_{A3} and PO_{A4}, coordinator 120 issues an instruction to the execution engine of system 140b to execute node LO₁ using physical operator PO_{B1} and an instruction to the execution engine of system 140n to execute node LO₂ using physical operator PO_{C2}. Coordinator 120 then issues an instruction to the execution engine of system 140a to execute node LO₃ using physical operator PO_{A3} and the output of physical operators PO_{B1} and PO_{C2}. Lastly, coordinator 120 issues an instruction to the execution engine of system 140a to execute node LO₄ using physical operator PO_{A4}, and using the output of physical operator PO_{A3} (which executed node LO₃).

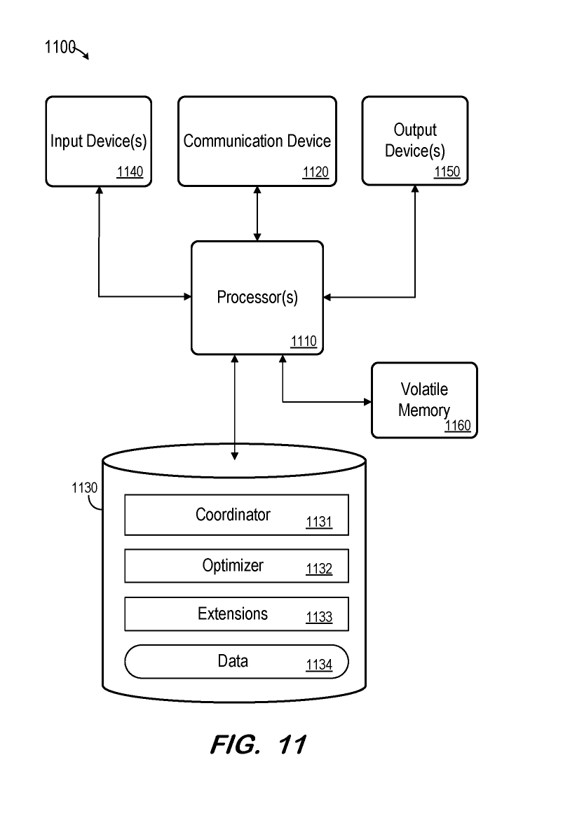

According to some embodiments, the number of combinations of physical operators evaluated at S275 may be reduced by determining, for each logical operator of an operation level, a physical operator associated with a smallest total resource estimate. These physical operators will be assumed to be the inputs to the logical operators of the next operation level. FIG. 10 illustrates table 400 as generated in such a scenario.

In some embodiments, identification of physical operators corresponding to a logical operator at S225 and S250 may be ordered based on the location of the inputs to the logical operator. For example, in case logical query execution plan QP₁, optimizer 122 may ask extension 124 first for a physical operator corresponding to Select(T.c>100, T), because table T resides in system 140a. Similarly, optimizer 122 may ask extension 126 first for a physical operator corresponding to Select(S.c<100, S), because table S resides in system 140b.

After receiving a physical operator for Select(T.c>100, T) from extension 122, a resource usage estimate for the physical operator is passed as a bound when asking extensions 124 and 126 for a corresponding physical operator, so that the extensions can stop processing immediately if it cannot provide a cheaper physical operator. Since handling the operation in system 140b or 140n requires conversion of table T into other formats, extensions 124 and 126 can return immediately after checking only the resource usage of the conversion. If the resource usage estimate for the physical operator received from extension 122 is fairly small, some embodiments will omit asking extensions 124 and 126 for a corresponding physical operator under the assumption that the resource usage of the conversion alone is greater than the resource usage estimate for the physical operator received from extension 122.

FIG. 11 is a block diagram of apparatus 1100 according to some embodiments. Apparatus 1100 may comprise a general-purpose computing apparatus and may execute program code to perform any of the functions described herein. Apparatus 1100 may comprise an implementation of coordinator 120 and data store 110 in some embodiments. Apparatus 1100 may include other unshown elements according to some embodiments.

Apparatus 1100 includes processor(s) 1110 operatively coupled to communication device 1120, data storage device 1130, one or more input devices 1140, one or more output devices 1150 and memory 1160. Communication device 1120 may facilitate communication with external devices, such as a reporting client, or a data storage device. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into apparatus 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM).

Coordinator 1131, optimizer 1132 and extensions 1133 may each comprise program code executed by processor(s) 1110 to cause apparatus 1100 to perform any one or more of the processes described herein. Embodiments are not limited to execution of these processes by a single apparatus.

Data 1134 may include conventional database data as described above. As also described above, database data (either cached or a full database) may be stored in volatile memory such as volatile memory 1160. Data storage device 1130 may also store data and other program code for providing additional functionality and/or which are necessary for operation of apparatus 1100, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing first processor-executable program code; and
a processor to execute the processor-executable program code in order to cause the system to:
receive a database query;
determine a first logical query execution plan to execute the database query over heterogeneous execution engines;
select a first logical operator of a first operation level of the first logical query execution plan;
identify a first one or more physical operators corresponding to the first logical operator and an output format of each of the first one or more physical operators, each of the first one or more physical operators provided by a respective distributed execution engine;
select a second logical operator of a second operation level of the first logical query execution plan, the second logical operator to receive output from the first logical operator;
identify a second one or more physical operators corresponding to the second logical operator, each of the second one or more physical operators provided by a respective one of the heterogeneous execution engines;
determine a first resource usage estimate for each of the first one or more physical operators;
determine one or more second resource usage estimates for each of the second one or more physical operators, based on the respective output format of each of the first one or more physical operators; and
determine one of the first one or more physical operators and one of the second one or more physical operators based on the determined first resource usage estimates and the determined second resource usage estimates.

2. A system according to claim 1, wherein determination of one of the first one or more physical operators and one of the second one or more physical operators comprises:
determination of a total resource usage estimate for each combination of one of the first one or more physical operators and one of the second one or more physical operators based on the determined first resource usage estimates and the determined second resource usage estimates; and
determination of a combination based on the determined total resource usage estimates.

3. A system according to claim 1, wherein determination one or more second resource usage estimates for each of the second one or more physical operators comprises:
for each of the first one or more physical operators, determine a second resource usage estimate for each of the second one or more physical operators, based on the respective output format of the first physical operator.

4. A system according to claim 1, the processor to further execute the processor-executable program code in order to cause the system to:
determine a second logical query execution plan to execute the database query;
select a third logical operator of a first operation level of the second logical query execution plan;
identify a third one or more physical operators corresponding to the third logical operator and an output format of each of the third one or more physical operators, each of the third one or more physical operators provided by a respective one of the heterogeneous execution engines;
select a fourth logical operator of a second operation level of the second logical query execution plan, the fourth logical operator to receive output from the third logical operator;
identify a fourth one or more physical operators corresponding to the fourth logical operator, each of the fourth one or more physical operators provided by a respective one of the heterogeneous execution engines;
determine a third resource usage estimate of each of the third one or more physical operators; and
determine one or more fourth resource usage estimates of each of the fourth one or more physical operators, based on the respective output format of each of the third one or more physical operators.

5. A system according to claim 4, wherein determination of one of the first one or more physical operators and one of the second one or more physical operators comprises:
determination of a total resource usage estimate for each combination of one of the first one or more physical operators and one of the second one or more physical operators based on the determined first resource usage estimates and the determined second resource usage estimates;
determination of a total resource usage estimate for each combination of one of the third one or more physical operators and one of the fourth one or more physical operators based on the determined third resource usage estimates and the determined fourth resource usage estimates; and
determination of a combination of one of the first one or more physical operators and one of the second one or more physical operators based on the determined total resource usage estimates.

6. A system according to claim 1, wherein identification of a first one or more physical operators corresponding to the first logical operator and an output format of each of the first one or more physical operators comprises querying a locally-executed extension corresponding to each of the heterogeneous execution engines.

7. A system according to claim 1, further comprising:
a plurality of distributed data storage systems, each of the plurality of distributed data storage systems comprising one of the heterogeneous execution engines.

8. A computer-implemented method, comprising:
receiving a database query;
determining a first logical query execution plan to execute the database query over a plurality of heterogeneous execution engines, the first logical query execution plan comprising a plurality of first logical operators, each of the first logical operators associated with an operation level of the first logical query execution plan;
determining, for each of the plurality of first logical operators, one or more physical operators, each of the one or more physical operators provided by a respective one of the plurality of heterogeneous execution engines;
determining a plurality of combinations of the determined physical operators, where each combination comprises exactly one physical operator determined for each one of the plurality of first logical operators;
determining a total resource usage estimate for each of the plurality of combinations of the determined physical operators, wherein a resource usage estimate of at least one physical operator of a combination is based on an output format of another physical operator of the combination which is associated with a lower operation level than the at least one physical operator; and
determining one of the combinations to execute based on the determined total resource usage estimates.

9. A method according to claim 8, further comprising:
determining a second logical query execution plan to execute the database query, the second logical query execution plan comprising a plurality of second logical operators, each of the second logical operators associated with an operation level of the second logical query execution plan;
determining, for each of the plurality of second logical operators, a second one or more physical operators, each of the second one or more physical operators provided by a respective one of the heterogeneous execution engines;
determining a second plurality of combinations of the determined second physical operators, where each of the second plurality of combinations comprises exactly one physical operator determined for each one of the plurality of second logical operators; and
determining a total resource usage estimate for each of the second plurality of combinations of the determined second physical operators, wherein a resource usage estimate of at least one second physical operator of a combination is based on an output format of another second physical operator of the combination which is associated with a lower operation level than the at least one second physical operator, wherein
determining one of the combinations to execute comprises determining one of the first plurality combinations and second plurality of combinations to execute based on the determined total resource usage estimates.

10. A method according to claim 8, wherein determining one or more physical operators for each of the plurality of first logical operators comprises querying a locally-executed extension corresponding to each of the plurality of heterogeneous execution engines.

11. A non-transitory computer-readable medium storing program code, the program code executable to:
receive a database query;
determine a first logical query execution plan to execute the database query over a plurality of heterogeneous execution engines;
select a first logical operator of a first operation level of the first logical query execution plan;
identify a first one or more physical operators corresponding to the first logical operator and an output format of each of the first one or more physical operators, each of the first one or more physical operators provided by a respective one of the heterogeneous execution engines;
select a second logical operator of a second operation level of the first logical query execution plan, the second logical operator to receive output from the first logical operator;
identify a second one or more physical operators corresponding to the second logical operator, each of the second one or more physical operators provided by a respective one of the heterogeneous execution engines;
determine a first resource usage estimate for each of the first one or more physical operators;
determine one or more second resource usage estimates for each of the second one or more physical operators, based on the respective output format of each of the first one or more physical operators; and
determine one of the first one or more physical operators and one of the second one or more physical operators based on the determined first resource usage estimates and the determined second resource usage estimates.

12. A medium according to claim 11, wherein determination of one of the first one or more physical operators and one of the second one or more physical operators comprises:
determination of a total resource usage estimate for each combination of one of the first one or more physical operators and one of the second one or more physical operators based on the determined first resource usage estimates and the determined second resource usage estimates; and
determination of a combination based on the determined total resource usage estimates.

13. A medium according to claim 11, wherein determination of one or more second resource usage estimates for each of the second one or more physical operators comprises:
for each of the first one or more physical operators, determination of a second resource usage estimate for each of the second one or more physical operators, based on the respective output format of the first physical operator.

14. A medium according to claim 11, the program code further executable to:
determine a second logical query execution plan to execute the database query;
select a third logical operator of a first operation level of the second logical query execution plan;
identify a third one or more physical operators corresponding to the third logical operator and an output format of each of the third one or more physical operators, each of the third one or more physical operators provided by a respective one of the heterogeneous execution engines;
select a fourth logical operator of a second operation level of the second logical query execution plan, the fourth logical operator to receive output from the third logical operator;
identify a fourth one or more physical operators corresponding to the fourth logical operator, each of the fourth one or more physical operators provided by a respective one of the heterogeneous execution engines;
determine a third resource usage estimate of each of the third one or more physical operators; and
determine one or more fourth resource usage estimates of each of the fourth one or more physical operators, based on the respective output format of each of the third one or more physical operators.

15. A medium according to claim 14, wherein determination of one of the first one or more physical operators and one of the second one or more physical operators comprises:
determination of a total resource usage estimate for each combination of one of the first one or more physical operators and one of the second one or more physical operators based on the determined first resource usage estimates and the determined second resource usage estimates;
determination of a total resource usage estimate for each combination of one of the third one or more physical operators and one of the fourth one or more physical operators based on the determined third resource usage estimates and the determined fourth resource usage estimates; and
determination of a combination of one of the first one or more physical operators and one of the second one or more physical operators based on the determined total resource usage estimates.

16. A medium according to claim 11, wherein identification of a first one or more physical operators corresponding to the first logical operator and an output format of each of the first one or more physical operators comprises querying of a locally-executed extension corresponding to each of the plurality of heterogeneous execution engines.
